(19) United States
(12) Patent Application Publication
(10) Pub. No.: US 2025/0002670 A1
(43) Pub. Date: Jan. 2, 2025

(54) DEPOLYMERIZATION SYSTEM

(71) Applicant: Honda Motor Co., Ltd., Tokyo (JP)

(72) Inventors: Tsuyoshi Baba, Wako-shi (JP); Shuta Suzuki, Wako-shi (JP)

(21) Appl. No.: 18/749,610

(22) Filed: Jun. 21, 2024

(30) Foreign Application Priority Data
Jun. 27, 2023 (JP) 2023-105289

(51) Int. Cl. C08J 11/14

(52) U.S. Cl. CPC C08J 11/14; C08J 2377/02

(57) ABSTRACT

A depolymerization system including: a dissolver configured to dissolve a resin using a solvent; a solid-liquid separator configured to separate a solution containing the resin and the solvent dissolved by the dissolver into a solid and a liquid; an evaporator configured to evaporate the solvent contained in the liquid separated from the solution; a depolymerizer configured to perform a depolymerization reaction between the liquid from which the solvent is evaporated by the evaporator and water; a concentrator configured to heat and concentrate a reaction product of the depolymerizer, a condenser configured to condense a vapor of the solvent generated in the evaporator; and a heat transferrer configured to transfer a condensing heat generated when the vapor of the solvent is condensed by the condenser to the dissolver and the concentrator.

### CROSS-REFERENCE TO RELATED APPLICATION

This application is based upon and claims the benefit of priority from Japanese Patent Application No. 2023-105289 filed on Jun. 27, 2023, the content of which is incorporated herein by reference.

### BACKGROUND

### Technical Field

The present invention relates to a depolymerization system configured to recover a raw material from a plastic.

### Related Art

In recent years, efforts to significantly reduce the generation of waste have been activated by preventing, reducing, regenerating, and reusing the waste. As this type of technology, there is known an apparatus in which waste plastic is heated by heat of combustion gas generated by a combustion reaction of fuel with oxygen-containing gas to convert the waste plastic into oil or gas (see, for example, JP 2001-181651 A). The apparatus described in JP 2001-181651 A is configured to reuse the residual heat of the combustion gas for heating the oxygen-containing gas before combustion.

In general, when the waste plastic is depolymerized to recover a raw material monomer, the waste plastic is dissolved in a solvent, foreign matters are separated, and then the solvent is degassed and put into a depolymerization apparatus. The solvent evaporated in such a degassing process is condensed and reused. However, energy from the outside is required to condense the solvent, and it is preferable to efficiently condense the solvent.

### SUMMARY

An aspect of the present invention is a depolymerization system including: a dissolver configured to dissolve a resin using a solvent; a solid-liquid separator configured to separate a solution containing the resin and the solvent dissolved by the dissolver into a solid and a liquid; an evaporator configured to evaporate the solvent contained in the liquid separated from the solution; a depolymerizer configured to perform a depolymerization reaction between the liquid from which the solvent is evaporated by the evaporator and water; a concentrator configured to heat and concentrate a reaction product of the depolymerizer, a condenser configured to condense a vapor of the solvent generated in the evaporator; and a heat transferrer configured to transfer a condensing heat generated when the vapor of the solvent is condensed by the condenser to the dissolver and the concentrator.

### BRIEF DESCRIPTION OF DRAWINGS

The objects, features, and advantages of the present invention will become clearer from the following description of embodiments in relation to the attached drawings, in which:

FIG. 1 is a diagram illustrating an example of a configuration of a depolymerization system according to an embodiment of the present invention.

### DETAILED DESCRIPTION

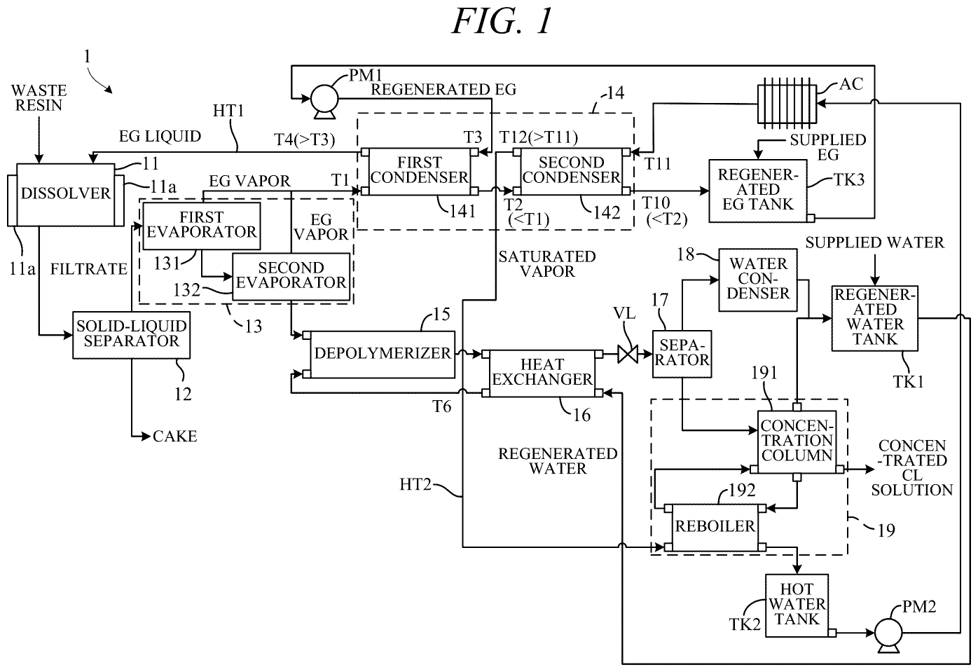

Hereinafter, an embodiment of the present invention will be described with reference to FIG. 1. A depolymerization system 1 according to the embodiment of the present invention recovers a raw material monomer from waste plastic (hereinafter, referred to as a waste resin) used for components of a vehicle (interior parts, bumpers, and the like). Specifically, the depolymerization system 1 depolymerizes polyamide 6 (hereinafter, referred to as PA6) contained in the waste resin and recovers ε-caprolactam (hereinafter, referred to as CL). The waste resin is, for example, polyamide 6 (hereinafter, referred to as PA6GF) in which glass fibers (hereinafter, referred to as GF) are blended.

In a case of recovering CL from PA6GF, in order to separate GF from PA6GF, PA6GF is first dissolved using ethylene glycol (hereinafter, referred to as EG) as a solvent, and the solution is subjected to solid-liquid separation to remove GF from the solution. Hereinafter, EG to be used as the solvent is referred to as an EG liquid. Thereafter, EG contained in the solution is evaporated and removed, and the solution from which EG has been removed is put into a depolymerizer. EG evaporated at this time is condensed and reused for dissolution of PA6GF.

However, since much waste heat is generated by condensation of EG, sufficient efficiency cannot be obtained in terms of energy only by simply condensing and reusing EG as described above. In order to cope with such a problem, in the present embodiment, a depolymerization system is configured as follows.

FIG. 1 is a diagram illustrating an example of a configuration of the depolymerization system according to the embodiment of the present invention. As illustrated in FIG. 1, the depolymerization system 1 includes a dissolver 11 that dissolves a waste resin using EG, a solid-liquid separator 12 that separates a solution containing the waste resin and EG dissolved by the dissolver 11 into a solid and a liquid, an EG evaporator (hereinafter, simply referred to as an evaporator) 13 that evaporates EG contained in the liquid (hereinafter, referred to as a filtrate) separated from the solution, a depolymerizer 15 that performs a depolymerization reaction between water and the filtrate obtained by evaporating EG by the evaporator 13, and an EG condenser (hereinafter, simply referred to as a condenser) 14 that condenses vapor (hereinafter, referred to as EG vapor) of EG generated by the evaporator 13.

The depolymerization system 1 further includes a heat exchanger 16 that exchanges heat between water and a reaction product (hereinafter, also referred to as a depolymerization liquid) of the depolymerizer 15, a separator 17 that separates the depolymerization liquid into a gas phase and a liquid phase, a condenser (hereinafter, referred to as a water condenser or a gas phase condenser) 18 that condenses the gas phase separated from the depolymerization liquid by the separator 17, a CL concentrator (hereinafter, simply referred to as a concentrator) 19 that concentrates the liquid phase (CL) separated from the depolymerization liquid by the separator 17, a regenerated water tank TK1 in which a liquid phase (water) obtained by condensing the gas phase by the water condenser 18 and a distillate (water) discharged from the concentrator 19 are stored, a hot water tank TK2 that stores hot water (hereinafter, referred to as a discharge liquid) discharged from the concentrator 19, and a regenerated EG tank TK3 that stores a liquid (hereinafter, referred to as regenerated EG) of EG obtained by condensing the EG vapor by the condenser 14.

In the depolymerization system 1, first, the waste resin (PA6GF) and the solvent (EG) are put into the dissolver 11 at a predetermined mass ratio (for example, PA6GF:EG=1:5), and PA6GF and EG are heated by a heater 11a. At this time, when PA6GF and EG in the dissolver 11 are heated at a temperature (for example, 150° C.) or higher for a certain time (for example, 45 minutes), PA6GF is dissolved by EG. Note that the heating temperature and heating time for dissolution vary depending on a pulverization size and a stirring condition of PA6GF, a mass ratio between PA6GF and EG, and the like.

A solution of PA6GF and EG is sent from the dissolver 11 to the solid-liquid separator 12 which is a centrifuge. The viscosity of the solution gradually increases at a predetermined temperature (about 150° C.) or lower, and becomes a high viscosity state having almost no fluidity at a temperature (about 130° C. or lower) lower than the predetermined temperature. Therefore, the solid-liquid separator 12 has a structure that retains the solution with heat medium oil (hereinafter, simply referred to as a heat medium) so as to be able to retain the solution at a temperature (about 150° C.) higher than the temperature. Note that a foreign matter separation filter may be provided instead of the centrifuge or in addition to the centrifuge.

In the solid-liquid separator 12, the solution is separated into a filtrate and a cake (solid). Since the filtrate contains EG, EG contained therein is evaporated by the evaporator 13. The cake also contains EG. Specifically, a small amount of EG remains on a surface of the cake. EG contained in the cake is evaporated at a predetermined temperature (for example, 200° C.) using a tube heating type evaporator, a rotary kiln, or the like (not illustrated). For evaporation of EG contained in the cake, a container rotary type dryer, a cone type mixer with a stirring blade, or the like may be used.

The evaporator 13 includes a first evaporator 131 and a second evaporator 132 provided at a subsequent stage thereof.

First, the first evaporator 131 decompresses the filtrate to a predetermined pressure (for example, 0.02 MPa) at a predetermined temperature (about 200° C.) to evaporate EG contained in the filtrate.

When EG evaporates, the viscosity of the filtrate increases. When the viscosity of the filtrate increases, degassing of EG becomes difficult. For this reason, the filtrate sent from the first evaporator 131, that is, the filtrate having the increased viscosity may contain EG remaining without being degassed. Therefore, the second evaporator 132 is provided at the subsequent stage of the first evaporator 131, and EG remaining in the filtrate is degassed by the second evaporator 132. The second evaporator 132 is a twin screw extruder, and evaporates EG remaining in the filtrate while dissolving the filtrate sent from the first evaporator 131 at a predetermined temperature (for example, 250 to 300° C.). The filtrate (PA6) obtained by evaporating EG by the second evaporator 132 is then pumped to the depolymerizer 15 via a gear pump (not illustrated) or the like.

The EG vapor generated by the evaporator 13 is condensed by the condenser 14, returned to a liquid, and put into the dissolver 11 as regenerated EG. The condenser 14 includes a first condenser 141 and a second condenser 142.

The first condenser 141 cools and condenses the EG vapor. The first condenser 141 uses the regenerated EG put as the solvent into the dissolver 11 as a medium (hereinafter, referred to as a cooling medium) for cooling the EG vapor. The first condenser 141 condenses the EG vapor by exchanging heat between the EG vapor and the regenerated EG. As a result, the EG vapor at a predetermined temperature T1 (for example, 170° C.) is cooled to a predetermined temperature T2 (for example, 149° C.). On the other hand, the regenerated EG to be the cooling medium is heated from a predetermined temperature T3 (for example, 90° C.) to a predetermined temperature T4 (for example, 160° C.) by condensing heat generated when the EG vapor is condensed. The regenerated EG (EG liquid) heated to the predetermined temperature T4 is supplied to the dissolver 11 through a heat transferrer HT1 including a pipe communicating from the first condenser 141 to the dissolver 11, a pump provided in the pipe, and the like. As a result, the condensing heat of the first condenser 141 is transferred to the dissolver 11.

Note that the heat exchange in the first condenser 141 alone cannot condense all of the EG vapor generated in the evaporator 13. Therefore, the EG vapor remaining without being condensed by the first condenser 141 is further condensed by the second condenser 142.

In the second condenser 142, the EG vapor (EG vapor that is partially condensed and becomes a liquid) at the predetermined temperature T2 sent from the first condenser 141 is condensed by heat exchange with water having a predetermined pressure (for example, 0.2 MPaG) and a predetermined temperature T11 (for example, 70° C.). As will be described later, the water is hot water (discharge liquid) discharged from the concentrator 19 (more specifically, a reboiler 192 described later), and is supplied from the concentrator 19 to the second condenser 142 through the hot water tank TK2. The water is heated by the heat exchange in the second condenser 142, that is, by condensing heat generated when the EG vapor is condensed, and becomes vapor (saturated vapor) at a predetermined temperature T12 (for example, 120° C.). The saturated vapor is supplied to the concentrator 19 through a heat transferrer HT2 including a pipe communicating from the second condenser 142 to the concentrator 19 (more specifically, the reboiler 192 described later), a pump provided in the pipe, and the like. As a result, the condensing heat of the second condenser 142 is transferred to the concentrator 19. On the other hand, the EG vapor condensed by the heat exchange in the second condenser 142 becomes a liquid (regenerated EG) at a predetermined temperature T10 (about 90° C.), and is stored in the regenerated EG tank TK3. The regenerated EG stored in the regenerated EG tank TK3 is supplied to the first condenser 141 through the pump PM1, heated by the condensing heat of the first condenser 141, and then reused in the dissolver 11. Note that the EG liquid is supplied to the regenerated EG tank TK3 as necessary.

Water (hereinafter, referred to as water for depolymerization) is supplied to the depolymerizer 15 in an amount of a predetermined multiple (for example, three times) of the amount of the filtrate (PA6) supplied from the second evaporator 132. The water for depolymerization is supplied from the regenerated water tank TK1 to the depolymerizer 15 through the heat exchanger 16. A reaction liquid (reaction product) generated by the depolymerization reaction in the depolymerizer 15 is supplied to the heat exchanger 16.

The heat exchanger 16 exchanges heat between the depolymerization liquid supplied from the depolymerizer 15 and the water for depolymerization at a predetermined temperature (for example, 50° C.) supplied from the regenerated water tank TK1. The heat exchanger 16 supplies the water for depolymerization heated by the heat exchange with the depolymerization liquid to the depolymerizer 15. As described above, by heating the water for depolymerization before putting it into the depolymerizer 15, the heating amount at the time of depolymerizing the filtrate (PA6) in the depolymerizer 15 can be reduced. In addition, the heat exchanger 16 supplies the depolymerization liquid cooled by the heat exchange with the water for depolymerization to the separator 17 through an opening/closing portion VL. The opening/closing portion VL is a valve for adjusting the amount of depolymerization liquid to be supplied to the separator 17.

The separator 17 separates the depolymerization liquid into a gas phase and a liquid phase. The gas phase is sent to the water condenser 18, condensed in the water condenser 18 to become a liquid phase (specifically, water), stored in the regenerated water tank TK1, and then reused as the water for depolymerization in the depolymerizer 15. The liquid phase is sent to the concentrator 19. The concentrator 19 concentrates CL, which is a main component of the depolymerization liquid. The depolymerization liquid (hereinafter, referred to as a concentrated CL solution) concentrated to a predetermined concentration (about 80%) by the concentrator 19 is then transported to a factory or the like having a polymerization facility. The distillate (water) in the concentrator 19 is stored in the regenerated water tank TK1 and then reused as the water for depolymerization in the depolymerizer 15. Note that water is supplied to the regenerated water tank TK1 as necessary.

The concentrator 19 includes a concentration column 191 and a reboiler 192 for heating a solution (depolymerization liquid) in the concentration column 191. The saturated vapor at the predetermined temperature T12 obtained by the second condenser 142 is supplied to the reboiler 192 and used for reboiler heating. The saturated vapor used for reboiler heating becomes hot water and is discharged from the reboiler 192. The hot water (discharge liquid) is supplied to the second condenser 142 as described above. Specifically, the hot water discharged from the reboiler 192 is stored in the hot water tank TK2, and pumped from the hot water tank TK2 to the second condenser 142 through a pump PM2. The hot water supplied to the second condenser 142 is used for heat exchange with the EG vapor in the second condenser 142. Since the amount of heat of the vapor discharged from the second condenser 142 is larger than the amount of heat required for reboiler heating, the hot water discharged from the reboiler 192 has a high temperature (>predetermined temperature T11). Such high-temperature hot water is not suitable for heat exchange with the EG vapor in the second condenser 142. Therefore, an air cooler AC for cooling the hot water supplied to the second condenser 142 to the predetermined temperature T11 is provided between the pump PM2 and the second condenser 142.

The hot water supplied from the concentrator 19 to the second condenser 142 through the hot water tank TK2 and the air cooler AC again becomes saturated vapor at the predetermined temperature T12 by condensing heat of the second condenser 142, and the saturated vapor is supplied from the second condenser 142 to the concentrator 19 through the heat transferrer HT2 to be used for reboiler heating.

As described above, in the depolymerization system 1 of FIG. 1, waste heat (condensing heat) in the condensation process of EG is used for heating of the EG liquid and concentration of the depolymerization liquid by heat exchange.

According to the present embodiment, the following operations and effects are achievable.
(1) The depolymerization system 1 includes: a dissolver 11 that dissolves a waste resin (PA6GF) using a solvent (EG); a solid-liquid separator 12 that separates a solution containing the waste resin and the solvent dissolved by the dissolver 11 into a solid and a liquid; an evaporator 13 that evaporates the solvent contained in the liquid separated from the solution; a depolymerizer 15 that performs a depolymerization reaction between the liquid obtained by evaporating the solvent by the evaporator 13 and water; a concentrator 19 that heats and concentrates a reaction product (depolymerization liquid) of the depolymerizer 15; a condenser 14 that condenses vapor of the solvent generated in the evaporator 13; and heat transferrers HT1 and HT2 that transfer condensing heat generated when the vapor of the solvent is condensed by the condenser 14 to the dissolver 11 and the concentrator 19. As a result, waste heat generated by the condensation of EG can be effectively used for the heating of EG and the concentration of the depolymerized solution. Such reuse of thermal energy can provide an energy efficient system.
(2) The condenser 14 includes a first condenser 141 and a second condenser 142. The first condenser 141 condenses the vapor of the solvent generated in the evaporator 13 by heat exchange with a solvent used in the dissolver 11. The second condenser 142 condenses vapor that has not been condensed by the heat exchange of the first condenser 141 among the vapor generated in the evaporator 13, by heat exchange with a predetermined liquid (discharge liquid of the reboiler 192). A liquid of a solvent obtained from the vapor of the solvent by the condensation by the first condenser 141 and the second condenser 142 is supplied to the first condenser 141. The first condenser 141 condenses the vapor of the solvent generated in the evaporator 13 by heat exchange with the liquid of the solvent that has been supplied. The heat transferrer HT1 supplies the liquid of the solvent heated by the condensing heat of the solvent in the first condenser 141 to the dissolver 11 to transfer the condensing heat to the dissolver 11. The dissolver 11 dissolves the waste resin using the liquid of the solvent supplied through the heat transferrer HT1. As described above, by heating the liquid of the solvent before being put into the dissolver 11 with the condensing heat of the condenser 14, a heating amount required for dissolving the waste resin in the dissolver 11 can be reduced.
(3) The heat transferrer HT2 supplies vapor (saturated vapor) of a predetermined liquid generated by heat exchange of the second condenser 142 to the concentrator 19. The concentrator 19 heats the reaction product of the depolymerizer 15 using the vapor supplied through the heat transferrer HT2. As a result, an amount of heat of the vapor (saturated vapor) generated by the heat exchange of the second condenser 142 can be effectively used for reboiler heating of the concentrator 19.
(4) The concentrator 19 discharges the predetermined liquid cooled by being used for heating the reaction product of the depolymerizer 15. The second condenser 142 condenses vapor that has not been condensed by the heat exchange of the first condenser 141 among the vapor, by the heat exchange with the predetermined liquid discharged from the concentrator 19.
(5) The concentrator 19 concentrates a liquid phase separated from the reaction product of the depolymerizer 15. The depolymerization system further includes: a water condenser 18 that condenses a gas phase separated from the reaction product of the depolymerizer 15; and a heat exchanger 16 that heats water supplied to the depolymerizer 15 by heat exchange between liquid (water) obtained by condensing the gas phase by the water condenser 18 and a distillate (water) discharged from the concentrator 19. As a result, it is possible to reduce a heating amount when a filtrate (PA6) is depolymerized in the depolymerizer 15.

The above embodiment can be modified into various forms. Modifications are described below.

In the above embodiment, the case where the depolymerization system 1 recovers CL from PA6GF has been described as an example. However, the waste resin may be other than PA6GF, and the recovered raw material is not limited to CL. That is, the depolymerization system 1 may depolymerize a polymer other than the polyamide 6.

Further, in the above embodiment, the air cooler AC cools the hot water discharged from the concentrator 19 to a temperature suitable for heat exchange with the EG vapor in the second condenser 142. However, when the hot water discharged from the concentrator 19 has the temperature suitable for heat exchange with the EG vapor in the second condenser 142, cooling by the air cooler AC may be omitted. Further, in the above embodiment, the case where the waste resin is put into the dissolver 11 has been described as an example, but a resin may be put into the dissolver 11 instead of the waste resin. That is, the present invention is also applicable to a case where the resin itself is subjected to high purity decomposition.

The above embodiment can be combined as desired with one or more of the above modifications. The modifications can also be combined with one another.

According to the present invention, a raw material monomer can be efficiently recovered from a resin.

Above, while the present invention has been described with reference to the preferred embodiments thereof, it will be understood, by those skilled in the art, that various changes and modifications may be made thereto without departing from the scope of the appended claims.

What is claimed is:

1. A depolymerization system comprising:
a dissolver configured to dissolve a resin using a solvent;
a solid-liquid separator configured to separate a solution containing the resin and the solvent dissolved by the dissolver into a solid and a liquid;
an evaporator configured to evaporate the solvent contained in the liquid separated from the solution;
a depolymerizer configured to perform a depolymerization reaction between the liquid from which the solvent is evaporated by the evaporator and water;
a concentrator configured to heat and concentrate a reaction product of the depolymerizer, a condenser configured to condense a vapor of the solvent generated in the evaporator; and
a heat transferrer configured to transfer a condensing heat generated when the vapor of the solvent is condensed by the condenser to the dissolver and the concentrator.

2. The depolymerization system according to claim 1, wherein
the condenser includes a first condenser and a second condenser,
the first condenser is configured to condense the vapor of the solvent generated in the evaporator by a heat exchange with the solvent used in the dissolver, and
the second condenser is configured to condense the vapor which has not been condensed by the heat exchange of the first condenser among the vapor of the solvent generated in the evaporator, by a heat exchange with a predetermined liquid.

3. The depolymerization system according to claim 2, wherein
a liquid of the solvent obtained from the vapor of the solvent by condensation by the first condenser and the second condenser is supplied to the first condenser,
the first condenser is configured to condense the vapor of the solvent generated in the evaporator by the heat exchange with the liquid of the solvent,
the heat transferrer supplies the liquid of the solvent heated by the condensing heat generated when the vapor of the solvent is condensed in the first condenser to the dissolver, and
the dissolver is configured to dissolve the resin using the liquid of the solvent supplied through the heat transferrer.

4. The depolymerization system according to claim 2, wherein
the heat transferrer is configured to supply vapor of the predetermined liquid generated by the heat exchange of the second condenser to the concentrator, and
the concentrator is configured to heat the reaction product using the vapor of the predetermined liquid supplied through the heat transferrer.

5. The depolymerization system according to claim 4, wherein
the concentrator is configured to discharge the predetermined liquid cooled by being used for heating the reaction product, and
the second condenser is configured to condense the vapor which has not been condensed by the heat exchange of the first condenser among the vapor of the solvent generated in the evaporator, by the heat exchange with the predetermined liquid discharged from the concentrator.

6. The depolymerization system according to claim 1 further comprising
a gas phase condenser and a heat exchanger, wherein
the concentrator is configured to concentrate a liquid phase separated from the reaction product,
the gas phase condenser is configured to condense a gas phase separated from the reaction product, and
the heat exchanger is configured to heat the water supplied to the depolymerizer by a heat exchange with a liquid obtained by condensing the gas phase in the gas phase condenser and a distillate discharged from the concentrator.
